(19) United States
(12) Patent Application Publication
(10) Pub. No.: US 2014/0166141 A1
(43) Pub. Date: Jun. 19, 2014

(54) Reductant Injection System with Control Valve

(71) Applicant: TENNECO AUTOMOTIVE OPERATING COMPANY INC., Lake Forest, IL (US)

(72) Inventors: Michael Golin, Dexter, MI (US); Andre Bogacz, Ortonville, MI (US)

(73) Assignee: Tenneco Automotive Operating Company Inc., Lake Forest, IL (US)

(21) Appl. No.: 13/713,664

(22) Filed: Dec. 13, 2012

(51) Int. Cl. F16K 13/00

(52) U.S. Cl. CPC F16K 13/00
USPC 137/861

(57) ABSTRACT

An exhaust system including an exhaust flow path, an exhaust treatment fluid tank, and a dosing module in communication with the exhaust treatment fluid tank. A three-way valve communicates with the dosing module. A first nozzle and a second nozzle communicate with the three-way valve for dosing the exhaust treatment fluid into the exhaust flow path, wherein the three-way valve is operable to control an amount of the exhaust treatment fluid provided to the first and second nozzles from the dosing module.

### FIELD

The present disclosure relates to an exhaust treatment fluid injection control system.

### BACKGROUND

This section provides background information related to the present disclosure which is not necessarily prior art.

Combustion engines are known to produce emissions that may be harmful to the environment. In an effort to decrease the environmental impact that an engine may have, exhaust after-treatment systems have undergone comprehensive evaluation and development. Various components that assist in treating engine emission include oxidation and reduction catalysts that chemically react with the exhaust gases to produce less harmful emissions. To assist these catalysts in chemically reacting with the exhaust gases, the exhaust after-treatment system can include features such as exhaust treatment fluid dosing modules that inject an exhaust treatment fluid into the exhaust stream at positions upstream of the catalysts. When multiple dosing modules are used in a single after-treatment system, it is desirable to provide features and methods that control the dosing provided by the dosing modules to increase the efficiency, performance, and cost of the after-treatment system.

### SUMMARY

This section provides a general summary of the disclosure, and is not a comprehensive disclosure of its full scope or all of its features.

An exhaust system including an exhaust flow path, an exhaust treatment fluid tank, and a dosing module in communication with the exhaust treatment fluid tank. A three-way valve communicates with the dosing module. A first nozzle and a second nozzle communicate with the three-way valve for dosing the exhaust treatment fluid into the exhaust flow path, wherein the three-way valve is operable to control an amount of the exhaust treatment fluid provided to the first and second nozzles from the dosing module.

A controller can control the three-way valve and the dosing module.

The controller can actuate the three-way valve to control the amount of the exhaust treatment provided to each of the first and second nozzles.

The amount of exhaust treatment fluid provided to the first nozzle can be greater than the amount of exhaust treatment fluid provided to the second nozzle.

The first nozzle can dose the exhaust treatment fluid into the flow path at a location upstream of the second nozzle.

The exhaust system can also include a third nozzle and a fourth nozzle for dosing the exhaust treatment fluid into the flow path.

In addition, second dosing module and a second three-way valve communicate with the third nozzle, the fourth nozzle, and the exhaust treatment fluid tank. Further, a controller can control the first and second dosing module and the first and second three-way valves, wherein the second three-way valve is operable to control an amount of the exhaust treatment fluid provided to the third and fourth nozzles from the second dosing module. The controller may also be operable to actuate the first and second dosing modules and the first and second three-way valves to control the amount of the exhaust treatment provided to each of the first, second, third, and fourth dosing modules.

The flow path can include a first leg and a second leg, with the first nozzle being in communication with the first leg, and the second nozzle being in communication with the second leg.

The exhaust treatment fluid can be either a hydrocarbon exhaust treatment fluid or a urea exhaust treatment fluid.

The exhaust system can also include an exhaust treatment device selected from the group consisting of an oxidation catalyst, a particulate filter, and a selective catalytic reduction catalyst.

Also, a mixing device can be disposed in the flow path.

The present disclosure also provides an exhaust treatment system including an exhaust flow path including at least a first leg and a second leg, a first dosing module, a first three-way valve in communication with the first dosing module, and a first nozzle and a second nozzle in communication with the first three-way valve for dosing a first exhaust treatment fluid into the first and second legs, respectively. In addition, the exhaust treatment system can include a second dosing module, a second three-way valve in communication with the second dosing module, and a third nozzle and a fourth nozzle in communication with the second three-way valve for dosing a second exhaust treatment fluid into the first and second legs, respectively. The first and second three-way valves control an amount of the exhaust treatment fluid that is provided to each of the first, second, third, and fourth nozzles.

The exhaust treatment system can also include a controller that controls each of the first and second dosing modules, and controls each of the first and second three-way valves.

The first exhaust treatment fluid can be a hydrocarbon exhaust treatment fluid, and the second exhaust treatment fluid can be a urea exhaust treatment fluid.

The exhaust system may further include a plurality of exhaust treatment devices provided in each of the first and second legs, wherein the exhaust treatment devices include at least an oxidation catalyst and a selective catalytic reduction catalyst in each leg.

The first nozzle and the third nozzle can be operable to dose a greater amount of exhaust treatment fluid than the second nozzle and the fourth nozzle, respectively.

The present disclosure also provides an exhaust treatment system including an exhaust flow path, an exhaust treatment fluid tank, a first pair of nozzles in communication with the exhaust treatment fluid tank for dosing the exhaust treatment fluid into the flow path, a second pair of nozzles in communication with the exhaust treatment fluid tank for dosing the exhaust treatment fluid into the flow path, a first three-way valve in communication with the first pair of nozzles that divides the exhaust treatment fluid between the first pair of nozzles, a second three-way valve in communication with the second pair of nozzles that divides the exhaust treatment fluid between the second pair of nozzles, and a master three-way valve in communication the first and second three-way valves and the exhaust treatment fluid tank, wherein the master three-way valve is operable to control an amount of the exhaust treatment fluid provided to the first and second three-way valves from the exhaust treatment fluid tank.

The exhaust system can also include a dosing module in communication with the master three-way valve.

The exhaust system can also include a controller for controlling actuation of the first, second, and master three-way valves.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1-5 are schematic representations of exhaust treatment systems according to principles of the present disclosure;

Corresponding reference numerals indicate corresponding parts throughout the several views of the drawings.

### DETAILED DESCRIPTION

Example embodiments will now be described more fully with reference to the accompanying drawings.

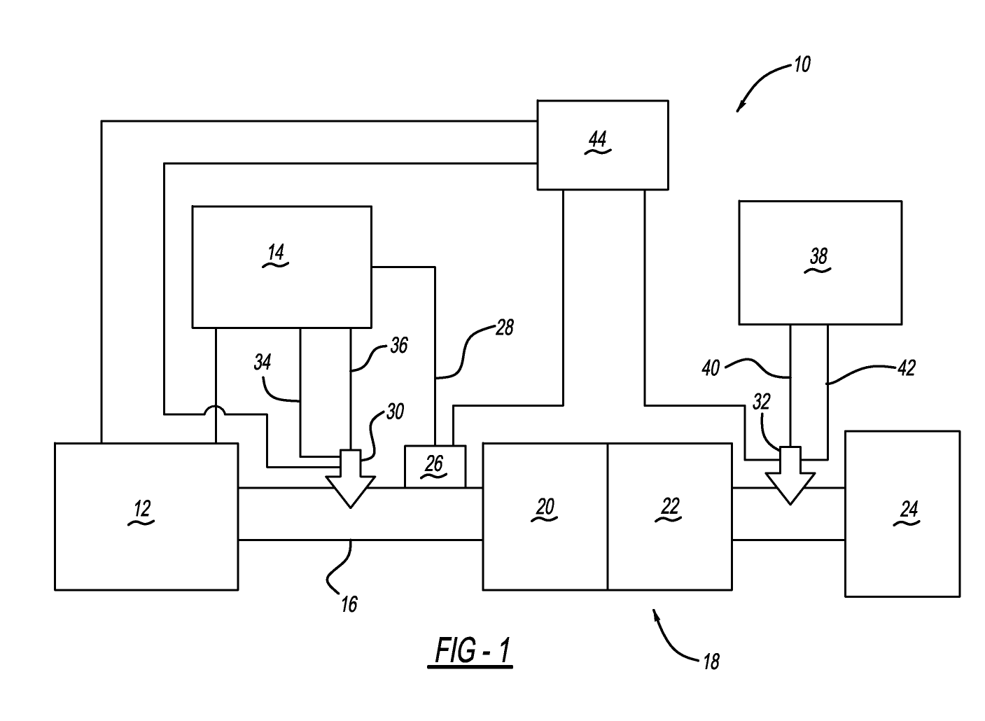

FIG. 1 is a schematic representation of an exhaust system 10 according to the present disclosure. Exhaust system 10 includes at least an engine 12 in communication with a fuel source 14 that, once consumed, will produce exhaust gases that are discharged into an exhaust passage 16 having an exhaust after-treatment system 18. Exhaust after-treatment system 18, in general, is located downstream from engine 12 and may include a diesel oxidation catalyst (DOC) component 20, a diesel particulate filter (DPF) component 22, and a selective catalytic reduction (SCR) component 24. Exhaust after-treatment system 18 may further include components such as a thermal enhancement device 26 (hereinafter burner 26) to increase a temperature of the exhaust gases passing through exhaust passage 16. Increasing the temperature of the exhaust gas may be favorable to achieve light-off of the catalyst in DOC and SCR components 20 and 24 in cold-weather conditions and upon start-up of engine 12, as well as initiate regeneration of DPF 22 when required. To provide fuel to burner 26, the burner can include an inlet line 28 in communication with fuel source 14.

DPF 24 may be desired as an exhaust treatment component to filter soot and any other particulate matters present in exhaust 14. When soot and the other particulate matter begins to clog the tiny pores (not shown) of the DPF 24, however, the DPF 24 can be cleaned (i.e., regenerated) by raising the temperature of the exhaust to burn off the excess soot and particulate matter from DPF 24. For the above reasons, burner 26 is preferably located upstream from each of DOC 20, SCR 24, and DPF 22. It should be understood, however, that DPF 22 may be located upstream of both DOC 20 and SCR 24 and include its own designated burner for regeneration purposes, while a second burner (not shown) can be located upstream of both DOC 20 and SCR 24. Another alternative is for each of DOC 20, SCR 24, and DPF 22 to include a designated burner.

To assist in reduction of the emissions produced by engine 12, exhaust after-treatment system 18 can include dosing modules 30 and 32 for periodically injecting exhaust treatment fluids into the exhaust stream. As illustrated in FIG. 1, dosing module 30 can be located upstream of DOC 20 and is operable to inject a hydrocarbon exhaust treatment fluid that assists in at least reducing NOₓ in the exhaust stream. In this regard, dosing module 30 is in fluid communication with fuel source 14 by way of inlet line 34 to inject a hydrocarbon such as diesel fuel into the exhaust passage 16 upstream of DOC 20. Dosing module 30 can also be in communication with fuel source 14 via return line 36. Return line 36 allows for any hydrocarbon not injected into the exhaust stream to be returned to fuel source 14. Flow of hydrocarbon through inlet line 34, dosing module 30, and return line 36 also assists in cooling dosing module 30 so that dosing module 30 does not overheat. Other types of cooling, however, are contemplated. For example, dosing module 30 can be provided with a cooling jacket (not shown) where coolant can be passed through to cool dosing module 30. Dosing module 30 may alternatively be supplied with an exhaust treatment fluid other than fuel from tank 14 without departing from the scope of the present disclosure.

Dosing module 32 can be used to inject an exhaust treatment fluid such as urea into exhaust passage 16 at a location upstream of SCR 24. Dosing module 30 is in communication with a reductant tank 38 via inlet line 40. Dosing module 32 also is in communication with tank 38 via return line 42. Return line 42 allows for any urea not injected into the exhaust stream to be returned to tank 38. Similar to dosing module 30, flow of urea through inlet line 40, dosing module 32, and return line 42 also assists in cooling dosing module 32 so that dosing module 32 does not overheat. Dosing module 32, however, can also be provided with a cooling jacket (not shown) in a manner similar to dosing module 30.

A controller 44 may be provided to control various features of exhaust system 18, including engine 12 and exhaust treatment system 18. Specifically, with respect to controlling elements of exhaust treatment system 18, controller 44 may be operable to control burner 26 and dosing modules 30 and 32. To control each of these elements, various sensors (not shown) may be disposed at positions throughout exhaust treatment system 18 to monitor, for example, exhaust temperature, NOx concentration, pressure, flow rate, exhaust treatment fluid temperature and pressure, and the like.

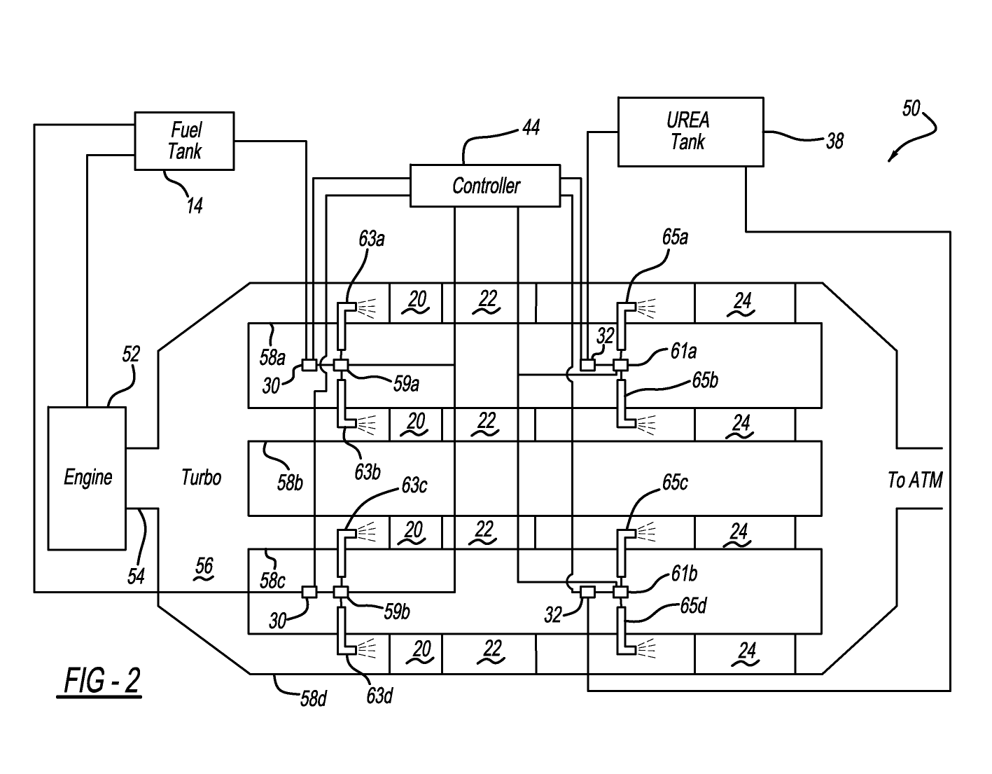

Large-scale diesel engines used in locomotives, marine applications, and stationary applications can have exhaust flow rates that exceed the capacity of a single exhaust line, like that schematically illustrated in FIG. 1. Accordingly, exhaust system 10 can be designed to include an exhaust after-treatment system that is a multi-leg system having a plurality of exhaust lines, with each of the exhaust lines having a DOC 20, DPF 22, and SCR 24. An exemplary multi-leg exhaust after-treatment system 100 is schematically illustrated in FIG. 2.

Accordingly, although only a single dosing module 30 is illustrated for hydrocarbon injection and only a single dosing module 32 is illustrated for urea injection, it should be understood that multiple dosing modules 30 and 32 for both hydrocarbon and urea injection are contemplated by the present disclosure.

In large engine applications such as locomotive, marine, and stationary applications, the production of various exhaust treatment components may be cost prohibitive due to the scale necessary to effectively treat the large amount of exhaust produced during operation of engine 12. In this regard, the ceramic substrates of, for example, the DOC 20, DPF 22, and SCR 24 can be very expensive to produce. For this reason, instead of making large-scale exhaust treatment components commensurate in size with the large engine application, the exhaust flow can be divided into a plurality of exhaust passages 16 that each includes a burner 26, DOC 20, DPF 22, and SCR 24.

FIG. 2 schematically illustrates a multi-leg exhaust after-treatment system 50. Multi-leg exhaust after-treatment system 50 is in communication with a large-scale engine 52 that produces large quantities of exhaust. Large-scale engine 52 can be an engine used in, for example, locomotive, stationary, and marine applications. Exhaust produced by engine 52 enters an exhaust passage 54 that may include a turbo manifold 56. At turbo manifold 56, the exhaust can be divided into a plurality of legs 58a, 58b, 58c, and 58d. It should be understood that although only four legs 58a-58d are illustrated in FIG. 2, the present disclosure should not be limited thereto. In this regard, multi-leg exhaust treatment system 50 can include a less than four legs 58, or a number of legs 58 greater than the four illustrated in FIG. 2.

Each leg 58a-58d can be configured to include a DOC 20, a DPF 22, and a SCR 24. Although not illustrated, it should be understood that each leg 58a-58d can also include a respective burner 26 for increasing a temperature of the exhaust stream to achieve light-off of catalysts in DOC 20 and SCR 24, as well as regenerate DPF 22, when necessary. Additionally, each leg 58a-58d can include dosing modules 30 and 32 for injecting exhaust treatment fluids such as hydrocarbon and urea treatment fluids at positions upstream of DOC 20 and SCR 24, respectively.

Exhaust after-treatment system 50 differs from exhaust after-treatment system 18 in that instead of each dosing module 30 and 32 being mounted to the legs 58a to 58d and directly dosing an exhaust treatment fluid into the legs 58a to 58d, each dosing module 30 and 32 communicates with a three-way valve 59 and 60 that in turn is coupled to a pair of nozzles 63 and 65, respectively. More specifically, because exhaust after-treatment system 50 in the exemplary illustrated embodiment includes four legs 58, a pair of dosing modules 30 and a pair dosing modules 32 are used to provide exhaust treatment fluids to the exhaust stream. Because each dosing module 30 and 32 is coupled to a three-way valve 59 and 61, each dosing module is in turn coupled to a pair of nozzles 63 and 65. Accordingly, a pair of hydrocarbon dosing modules 30 can be used to feed four nozzles 63 to provide hydrocarbon exhaust treatment fluid to each leg 58a to 58d, and a pair of urea dosing modules 32 can be used to feed four nozzles 61 to provide urea exhaust treatment fluid to each leg 58a to 58d. This is particularly advantageous in that dosing modules 30 and 32 are, in general, significantly more costly than nozzles 63 and 65. Dosing modules 30 and 32 are generally more expensive than nozzles 63 and 65 because dosing modules may include electromagnetically actuated pintles (not shown), while nozzles 63 and 65 are generally formed as a hollow tube having a predetermined orifice size (not shown) that ensures that the exhaust treatment fluid is sufficiently atomized when being provided into exhaust stream (i.e., the nozzles are devoid of a movable valve member). Regardless, the cost to produce exhaust treatment system 50 can be reduced by having a single dosing module feed multiple low-cost nozzles.

To control the amount of exhaust treatment fluid supplied to each individual nozzle 63 and 65, each three-way valve 59 and 61 may also be in communication with controller 44. Each three-way valve 59 and 61 can be either a pulse-width modulated (PWM) or a mechanically actuated valve. Regardless, as controller 44 is in communication with each valve 59 and 61, controller 44 can control actuation of each valve 59 and 61 to control an amount of exhaust treatment fluid provided to each leg 58 of exhaust after-treatment system 50. More particularly, for example, if a greater amount of hydrocarbon exhaust treatment fluid is needed in leg 58b in comparison to leg 58a, controller 44 can control actuation of three-way valve 59a such that a greater amount of fluid flow is allowed to pass through nozzle 63b into leg 58b than through nozzle 63a into leg 58a. This may be particularly desirable in cases where the exhaust is more apt to enter central legs 58b and 58c rather than outer legs 58a and 58d. Regardless, if the exhaust flow is found to be entering a particular leg more so than other legs, controller 44 can operate to increase the dosing of exhaust treatment fluid into the particular leg by controlling actuation of the particular three-way valve. The exhaust flow can be monitored using various sensors (not shown) such as mass flow sensors, NOx sensors, and the like.

Controller 44 is also operable to control three-way valves 61a and 61b in the same manner as three-way valves 59a and 59b. More particularly, for example, if a greater amount of urea exhaust treatment fluid is needed in leg 58b in comparison to leg 58a, controller 44 can control actuation of three-way valve 61a such that a greater amount of fluid flow is allowed to pass through nozzle 65b into leg 58b than through nozzle 65a into leg 58a. Again, this may be particularly desirable in cases where the exhaust is more apt to enter central legs 58b and 58c rather than outer legs 58a and 58d.

It should be understood that three-way valves 59 and 61 can be controlled to provide the entire flow to a particular nozzle, or can be controlled to provide a first portion of the flow to one nozzle and a second portion of the flow to another nozzle. For example, half of the flow can be directed to each nozzle in communication with the three-way valve. The percentage of flow provided to each nozzle, however, can be varied (e.g., 20% to one nozzle and 80% to the other nozzle, etc.), without limitation. Control over three-way valves 59 and 61 in this manner provides for greater active control over the dosing methodology that may be needed to sufficiently treat the exhaust stream.

Controller 44 allows for strict operational control of multi-leg exhaust after-treatment system 50. In some applications like locomotive, every increase and decrease in engine output can be predicted in advance by knowing the particular route upon which the locomotive will travel. For example, by knowing the particular route upon which the locomotive will travel, any grade change (e.g., change in elevation) upon the track will be known in advance. With this information, controller 44 can be programmed to know that an increase in engine output will be experienced at locations of increasing elevation, and that a decrease in engine output will be experienced at locations of decreasing elevation. With this knowledge, controller 44 can be operable to control after-treatment of the engine exhaust in a more active manner.

For example, if a locomotive is approaching a location of increasing elevation, controller 44 can be operable to predict that increased exhaust output will be experienced during increased engine output to accommodate for the increasing elevation. Controller 44, predicting that increased engine exhaust output is forthcoming, can proactively increase dosing of the exhaust treatment fluids into the exhaust stream by dosing modules 30 and 32. In particular, controller 44 can actuate dosing modules 30 and 32 to increase the amount of dosing into each leg 58a-58d.

Alternatively, if the locomotive is approaching a location of decreasing elevation, controller 44 can be operable to predict that decreased exhaust output will be experienced during decreased engine output. Controller 44 can then proactively decrease dosing of the exhaust treatment fluids into the exhaust stream by dosing modules 30 and 32. In particular, controller 44 can actuate dosing modules 30 and 32 to decrease the amount of dosing into each leg 58a-58d.

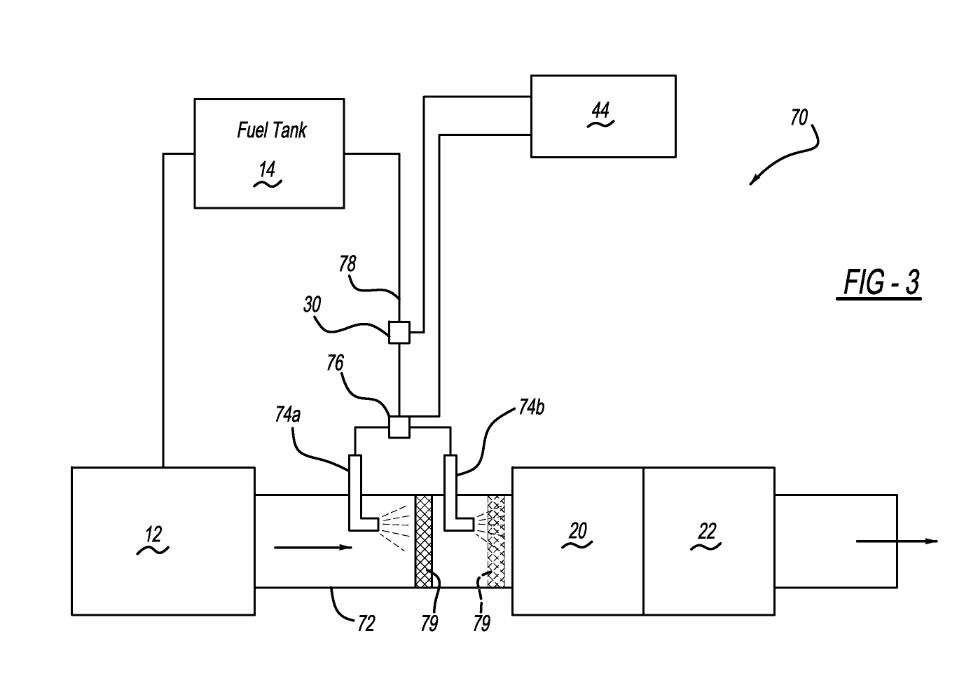

Now referring to FIG. 3, another exhaust after-treatment system 70 according to another principle of the present disclosure will be described. Exhaust after-treatment system 70 includes an exhaust flow path 72 downstream from an engine 12. In exhaust flow path 72 may be disposed an exhaust treatment device such as a DOC 20 as well as a DPF 22. Although not illustrated, it should be understood that after-treatment system 70 can also include an SCR 24, if desired.

As illustrated, after-treatment system 70 includes a single flow path 72. Notwithstanding the single flow path 72, after-treatment system 70 may still include a plurality of nozzles 74a and 74b, with each nozzle 74a and 74b being provided an exhaust treatment fluid from tank 14 through dosing module 30 and a three-way valve 76. Three-way valve 76 communicates with dosing module 30 and tank 14 via inlet line 78. After receiving exhaust treatment fluid from dosing module 30, three-way valve 76 divides the exhaust treatment fluid between nozzles 74a and 74b where the exhaust treatment fluid is dosed into the flow path 72. Between nozzles 74a and 74b may be disposed a mixing device 79. Although illustrated between nozzles 74a and 74b, it should be understood that mixing device 79 can be disposed upstream of nozzles 74a and 74b, or downstream of nozzles 74a and 74b, without departing from the scope of the present disclosure. Regardless, similar to the embodiment described with respect to FIG. 2, three-way valve 76 may be in communication with controller 44 to control actuation of three-way valve 76. By controlling dosing module 30 and three-way valve 76 with controller 44, the amount of exhaust treatment fluid can be varied between each nozzle 74a and 74b.

More specifically, nozzle 74a can be utilized as a “high flow” nozzle while nozzle 74b can be utilized as a “low flow” nozzle. To dose a larger amount of exhaust treatment fluid into flow path 72 using nozzle 74a, controller 44 can be used to actuate three-way valve 76 in a manner where a larger amount of the exhaust treatment fluid is directed to nozzle 74a. A larger amount of exhaust treatment fluid may desired upstream of mixer 78 due to the increased swirling of the exhaust gas and exhaust treatment fluid provided by mixer device 78. Although swirling is enhanced by mixing device 78, the amount of swirling may still be insufficient to properly intermix the exhaust treatment fluid and exhaust gas. Accordingly, by placing a “low flow” nozzle 74b downstream of the mixing device 78, any deficiency in swirling provided by mixing device 78 can be offset by the addition of additional reagent through nozzle 74b.

One skilled in the art will readily acknowledge and appreciate that while a “high flow” nozzle 74a may be desired at an upstream position relative to the “low flow” nozzle 74b, the present disclosure should not be limited thereto. That is, it is contemplated that nozzle 74a can be a “low flow” dosing module while nozzle 74b can be a “high flow” dosing module. This is simply accomplished through use of controller 44 to control actuation of three-way valve 78 such that more exhaust treatment fluid is provided to nozzle 74b rather than nozzle 74a.

It should be noted that the present disclosure should not be limited to controlling the amount of exhaust treatment fluid that is provided to each nozzle 74a and 74b to make each nozzle 74a and 74b either a “high flow” or a “low flow” nozzle. Rather than actively controlling the amount of exhaust treatment fluid provided to each nozzle 74a and 74b with a controllable three-way valve 76, the present disclosure also contemplates a exhaust after-treatment system where three-way valve 76 provides an equal amount of exhaust treatment fluid to each nozzle 74a and 74b. In such a configuration, an orifice size (not shown) of each nozzle 74a and 74b can be selected based on the desired amount of exhaust treatment fluid to be emitted by each nozzle 74a and 74b. Moreover, it should be understood that although nozzles 74a and 74b are illustrated as being disposed relative to each other in an axial direction, the present disclosure should not be limited thereto. In contrast, nozzles 74a and 74b may be arranged radially adjacent to each other about a circumference of exhaust flow path 72.

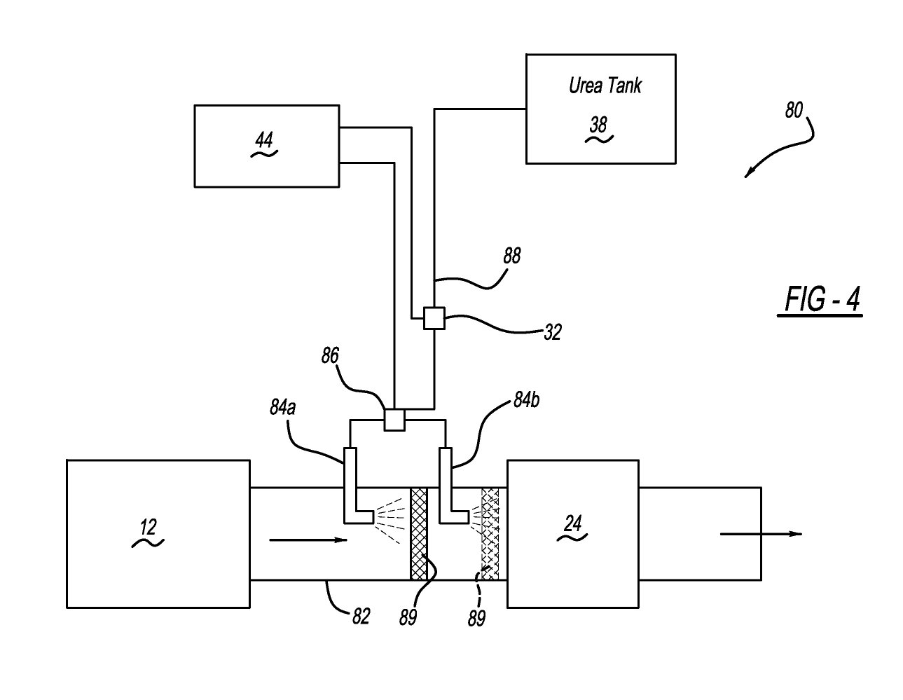

Now referring to FIG. 4, another exhaust after-treatment system 80 is illustrated. After-treatment system 80 is similar to after-treatment system 70, but is directed to a urea dosing system. As illustrated, after-treatment system 80 is in communication with an engine 12 by way of exhaust flow path 82. Within exhaust flow path 82 may be disposed an SCR catalyst 24 for selectively reducing NOx from the exhaust stream. To assist in this process, after-treatment system 80 can include a pair of nozzles 84a and 84b for dosing an aqueous urea exhaust treatment fluid into flow path 82.

Each nozzle 84a and 84b is provided the urea exhaust treatment fluid from tank 38 and dosing module 32 by way of three-way valve 86. Three-way valve 86 communicates with dosing module 32 and tank 38 via inlet line 88. After receiving the urea exhaust treatment fluid from dosing module 32, three-way valve 86 divides the exhaust treatment fluid between nozzles 84a and 84b where the urea exhaust treatment fluid is dosed into the flow path 82. Between nozzles 84a and 84b may be disposed a mixing device 89. Mixing device 89 can be disposed upstream of nozzles 84a and 84b, or downstream of nozzles 84a and 84b, without departing from the scope of the present disclosure. Regardless, similar to the embodiment described with respect to FIGS. 2 and 3, three-way valve 86 may be in communication with controller 44 to control actuation of three-way valve 86, which controls the amount of the urea exhaust treatment fluid divided between each nozzle 84a and 84b.

Similar to the exemplary embodiment of FIG. 3, nozzle 84a can be utilized as a “high flow” dosing module while nozzle 84b can be utilized as a “low flow” dosing module because a larger amount of exhaust treatment fluid may be desired upstream of mixer 89 due to the increased swirling of the exhaust gas and exhaust treatment fluid provided by mixer device 89. Although swirling is enhanced by mixing device 89, the amount of swirling may still be insufficient to properly intermix the urea exhaust treatment fluid and exhaust gas. Accordingly, by placing a “low flow” nozzle 84b downstream of the mixing device 89, any deficiency in swirling provided by mixing device 88 can be offset by the addition of additional reagent through nozzle 84b.

One skilled in the art will readily acknowledge and appreciate that while a “high flow” nozzle 84a may be desired at an upstream position relative to the “low flow” nozzle 84b, the present disclosure should not be limited thereto. That is, it is contemplated that nozzle 84a can be a “low flow” nozzle while nozzle 84b can be a “high flow” nozzle. This is simply accomplished through use of controller 44 to control actuation of three-way valve 86 such that more exhaust treatment fluid is provided to nozzle 84b rather than nozzle 84a, or by preselecting a particular orifice size (not shown) on each nozzle. Moreover, it should be understood that although nozzles 84a and 84b are illustrated as being disposed relative to each other in an axial direction, the present disclosure should not be limited thereto. In contrast, nozzles 84a and 84b may be arranged radially adjacent to each other about a circumference of exhaust flow path 82.

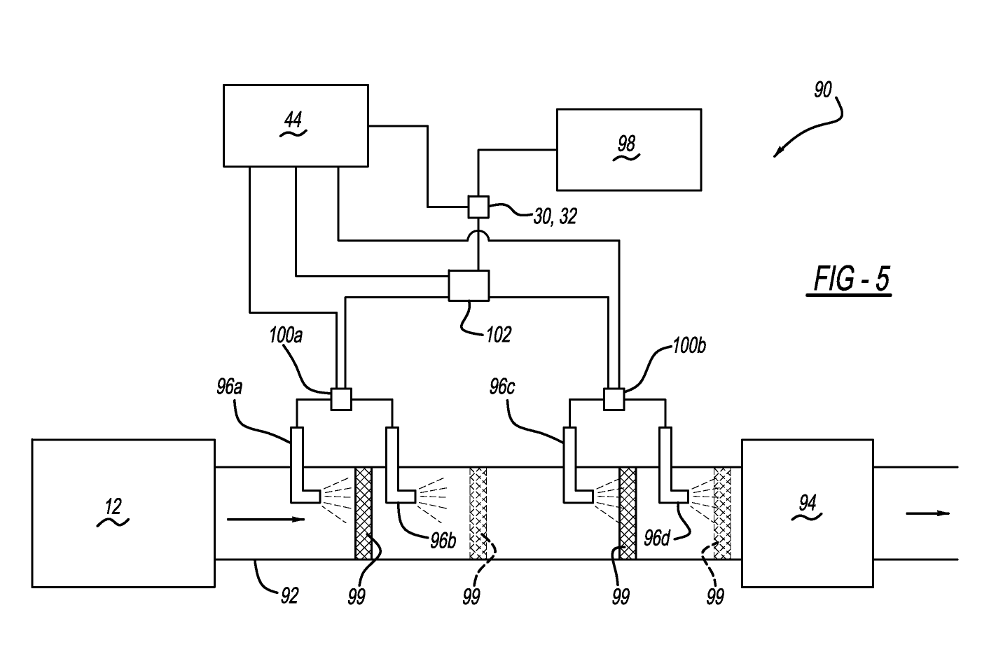

Now referring to FIG. 5, another exemplary exhaust after-treatment system 90 is illustrated. After-treatment system 90 is in communication with an engine 12, and includes an exhaust flow path 92. Disposed within flow path 92 may be an exhaust treatment device 94. Exhaust treatment device 94 can be either a DOC or a SCR catalyst treatment device. Upstream of exhaust treatment device 94 can be a plurality of nozzles 96a, 96b, 96c, and 96d. Nozzles 96a and 96b are provided an exhaust treatment fluid from exhaust treatment fluid tank 98 through a dosing module 30 or 32, a first three-way valve 102, and a second three-way valve 100a, while dosing modules 96c and 96d are provided exhaust treatment fluid from tank 98 through dosing module 30 or 32, first three-way valve 102, and a third three-way valve 100b. The exhaust treatment fluid may be either a hydrocarbon exhaust treatment fluid, or a urea exhaust treatment fluid. Similar to the previously-described embodiments, dosing module 30 or 32, first three-way valve 102, and second and third three-way valves 100a and 100b may be actuated through use of controller 44.

To provide exhaust treatment fluid to second and third three-way valves 100a and 100b, as noted above, second and third three-way valves 100a and 100b are also in communication with first three-way valve 102. Specifically, exhaust treatment fluid tank 98 communicates directly with first three-way valve 102, which then divides the exhaust treatment fluid in appropriate desired amounts to second and third three-way valves 100a and 100b. Controller 44 also controls actuation of first three-way valve 102 in a manner similar to second and third three-way valves 100a and 100b. Such a configuration additionally provides discrete control of dosing the exhaust treatment fluid into the exhaust flow path 92.

Nozzles 96a and 96b may be “high-flow” nozzles, while nozzles 96c and 96d may be “low-flow” nozzles. Alternatively, nozzles 96a and 96c may be “high-flow”nozzles, while nozzles 96b and 96d are “low-flow” nozzles. Regardless, control of the flow of exhaust treatment fluid through nozzles 96a-96d is governed by second and third three-way valves 100a and 100b, which in turn are governed by first three-way valve 102. All three valves 100a, 100b, and 102 are controlled by controller 44. Moreover, it should be understood that although nozzles 96a-96d are illustrated as being disposed relative to each other in an axial direction, the present disclosure should not be limited thereto. In contrast, nozzles 96a-96d may be arranged radially adjacent to each other about a circumference of exhaust flow path 72. Alternatively, nozzles 96a and 96b may be disposed radially adjacent to each other, with nozzles 96c and 96d being located axially downstream also being disposed radially adjacent to each other. A mixing device 99 can be disposed between each pair of nozzles 96a, 96b and 96c, 96d. Alternatively, a mixing device can be disposed downstream from each pair of nozzles 96a, 96b and 96c, 96d.

Lastly, it should be understood that any of three-way valves 100a, 100b, and 102 may be replaced by T-branch that evenly divides fluid flow between a pair of paths. For example, if master three-way valve 102 was replaced by a T-branch, an equal amount of flow could be directed to three-way valves 100a and 100b, where the flow would then be directed in the desired manner to each nozzle 96a-96d. Another exemplary configuration entails replacing three-way valves 100a and 100b with T-branches that receive fluid in the desired manner from master three-way valve 102.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An exhaust system, comprising:
an exhaust flow path;
an exhaust treatment fluid tank;
a dosing module in communication with the exhaust treatment fluid tank;
a three-way valve communicating with the dosing module; and
a first nozzle and a second nozzle communicating with the three-way valve for dosing the exhaust treatment fluid into the exhaust flow path,
wherein the three-way valve is operable to control an amount of the exhaust treatment fluid provided to the first and second nozzles from the dosing module.

2. The exhaust system of claim 1, further comprising a controller for controlling the three-way valve.

3. The exhaust treatment system of claim 1, wherein the controller actuates the three-way valve to control the amount of the exhaust treatment provided to each of the first and second nozzles.

4. The exhaust treatment system of claim 3, wherein the amount of exhaust treatment fluid provided to the first nozzle is greater than the amount of exhaust treatment fluid provided to the second nozzle.

5. The exhaust treatment system of claim 4, wherein the first nozzle doses the exhaust treatment fluid into the flow path at a location upstream of the second nozzle.

6. The exhaust treatment system of claim 1, further comprising a third nozzle and a fourth nozzle for dosing the exhaust treatment fluid into the flow path.

7. The exhaust treatment system of claim 6, further comprising a second dosing module and a second three-way valve communicating with the third nozzle, the fourth nozzle, and the exhaust treatment fluid tank; and
a controller for controlling the first and second dosing module and the first and second three-way valves,
wherein the second three-way valve is operable to control an amount of the exhaust treatment fluid provided to the third and fourth nozzles from the second dosing module; and
the controller is operable to actuate the first and second dosing modules and the first and second three-way valves to control the amount of the exhaust treatment provided to each of the first, second, third, and fourth dosing modules.

8. The exhaust treatment system of claim 1, wherein the flow path includes a first leg and a second leg, the first nozzle is in communication with the first leg, and the second nozzle is in communication with the second leg.

9. The exhaust treatment system of claim 1, wherein the exhaust treatment fluid is either a hydrocarbon exhaust treatment fluid or a urea exhaust treatment fluid.

10. The exhaust treatment system of claim 1, further comprising an exhaust treatment device selected from the group consisting of an oxidation catalyst, a particulate filter, and a selective catalytic reduction catalyst.

11. The exhaust treatment system of claim 1, further comprising a mixing device disposed in the flow path.

12. The exhaust treatment system of claim 1, wherein the first nozzle includes an exhaust treatment fluid exit orifice larger than an exit orifice of the second nozzle.

13. The exhaust treatment system of claim 12, wherein the first nozzle is positioned upstream of the second nozzle.

14. The exhaust treatment system of claim 13, further including a mixer positioned in the flow path between the first and second nozzles, or downstream from the first and second nozzles.

15. The exhaust treatment system of claim 1, wherein the first and second nozzles are devoid of a movable valve member.

16. An exhaust treatment system, comprising:
an exhaust flow path including at least a first leg and a second leg;
a first dosing module;
a first three-way valve in communication with the first dosing module; and
a first nozzle and a second nozzle in communication with the first three-way valve for dosing a first exhaust treatment fluid into the first and second legs, respectively;
a second dosing module;
a second three-way valve in communication with the second dosing module; and
a third nozzle and a fourth nozzle in communication with the second three-way valve for dosing a second exhaust treatment fluid into the first and second legs, respectively,
wherein the first and second three-way valves control an amount of the exhaust treatment fluid that is provided to each of the first, second, third, and fourth nozzles.

17. The exhaust treatment system of claim 16, further comprising a controller that controls each of the first and second dosing modules, and controls each of the first and second three-way valves.

18. The exhaust treatment system of claim 16, wherein the first exhaust treatment fluid is a hydrocarbon exhaust treatment fluid, and the second exhaust treatment fluid is a urea exhaust treatment fluid.

19. The exhaust treatment system of claim 16, further comprising a plurality of exhaust treatment devices provided in each of the first and second legs.

20. The exhaust treatment system of claim 19, wherein the exhaust treatment devices include at least an oxidation catalyst and a selective catalytic reduction catalyst in each leg.

21. The exhaust treatment system of claim 16, wherein the first nozzle and the third nozzle are operable to dose a greater amount of exhaust treatment fluid than the second nozzle and the fourth nozzle, respectively.

22. The exhaust treatment system of claim 16, wherein the first and third nozzles include an exhaust treatment fluid exit orifice larger than an exit orifice of the second and fourth nozzles.

23. The exhaust treatment system of claim 22, wherein the first nozzle and third nozzles are positioned upstream of the second and fourth nozzles, respectively.

24. The exhaust treatment system of claim 23, further including a mixer positioned in the flow path between the first and second nozzles, or downstream of the first and second nozzles.

25. The exhaust treatment system of claim 16, wherein the first, second, third, and fourth nozzles are devoid of a movable valve member.

26. An exhaust treatment system, comprising:
an exhaust flow path;
an exhaust treatment fluid tank;
a first pair of nozzles in communication with the exhaust treatment fluid tank for dosing the exhaust treatment fluid into the flow path;
a second pair of nozzles in communication with the exhaust treatment fluid tank for dosing the exhaust treatment fluid into the flow path;
a first three-way valve in communication with the first pair of nozzles that divides the exhaust treatment fluid between the first pair of nozzles;
a second three-way valve in communication with the second pair of nozzles that divides the exhaust treatment fluid between the second pair of nozzles; and
a master three-way valve in communication the first and second three-way valves and the exhaust treatment fluid tank;
wherein the master three-way valve is operable to control an amount of the exhaust treatment fluid provided to the first and second three-way valves from the exhaust treatment fluid tank.

27. The exhaust treatment system of claim 26, further comprising a dosing module in communication with the master three-way valve.

28. The exhaust treatment system of claim 26, further comprising a controller for controlling actuation of the first, second, and master three-way valves.

29. The exhaust treatment system of claim 26, wherein at least one nozzle of each pair of nozzles includes an exhaust treatment fluid exit orifice larger than an exit orifice of the other nozzle.

30. The exhaust treatment system of claim 29, wherein the at least one nozzle of each pair of nozzles is positioned upstream of the other nozzle.

31. The exhaust treatment system of claim 29, wherein each pair of nozzles includes a mixer disposed between the nozzles.

32. The exhaust treatment system of claim 26, wherein each of the nozzles are devoid of a movable valve member.
